(19) United States
(12) Patent Application Publication
(10) Pub. No.: US 2007/0081671 A1
(43) Pub. Date: Apr. 12, 2007

(54) Controlling deactivation of RFID tags

(76) Inventors: John Wayne Ross JR., Atlanta, GA (US); Frederick William Rowe, Raleigh, NC (US); Gregory Covert Smith, Raleigh, NC (US); Paul Michael Vanderlei, Grand Rapids, MI (US)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/247,418

(22) Filed: Oct. 11, 2005

(51) Int. Cl. H04K 1/00

(52) U.S. Cl. 380/255

(57) ABSTRACT

An RFID tag includes a transceiver for communicating with a tag reader; memory for storing a deactivation string, an encrypted deactivation string created externally to the tag by encrypting the deactivation string, and a trial string created externally to the tag by decrypting the encrypted deactivation; and logic for comparing the deactivation string and the trial string to determine whether they are the same, and, if they are the same, configuring the tag to permit deactivation. A method executed by the RFID tag includes comparing the trial string with the deactivation string to determine whether they are the same, and if they are the same, configuring the tag to permit deactivation. The trial string may be created externally to the tag by decrypting, using a first key, an encrypted deactivation string that is created externally to the tag by encrypting the deactivation string using a second key.

### BACKGROUND OF THE INVENTION

The invention pertains to the field of radio frequency identification (RFID) tags, and more particularly to controlling the deactivation of RFID tags, for example to ensure consumer privacy.

RFID tags have great potential for tracking objects such as retail goods from manufacture through final sale. The question of privacy, however, is an impediment to the greater use of such tags. Some consumers may be reluctant to accept goods that have RFID tags affixed, unless they are sure that the tag, and therefore a consumer's behavior, cannot continue to be tracked long after the time of purchase. As a result, ways of permanently deactivating or “killing” RFID tags are needed.

On the other hand, if RFID tags are to help merchants guard against shoplifting, for example, the tags cannot be deactivated too easily. Otherwise, a shoplifter might simply deactivate an RFID tag and remove an item supposedly tracked by the RFID tag from a merchant's store. Thus, authority to deactivate RFID tags should be controlled, ideally by the merchant, to be exercised only at the time and point of sale.

Further complicating the situation, RFID tags are now becoming well accepted at least in part because of their low cost. Keeping the cost of tags low, however, suggests that the tags themselves must be fairly simple. This need for simplicity limits the sophistication of techniques that can be used to control the deactivation of RFID tags, when such techniques require altering the basic structure of the RFID tag itself. Moreover, retail sales establishments often have limited or unreliable access to databases that might otherwise be used to control the deactivation of RFID tags.

Thus, there is a need for a way of controlling the deactivation of RFID tags that keeps authority at the point of sale for items tracked by RFID tags, and which neither complicates RFID tags unduly nor requires extensive reliance on database access.

### SUMMARY

One aspect of the invention includes a method for controlling deactivation of RFID tags. A deactivation string is encrypted externally to the RFID tag using a first key, to provide an encrypted deactivation string. The deactivation string and the encrypted deactivation string are written into memory of the RFID tag. The encrypted deactivation string is read from the RFID tag and decrypted externally to the RFID tag using a second key, to provide a trial string. The trial string is loaded into memory of the RFID tag. The RFID tag compares the trial string with the deactivation string to determine whether they are the same. If the trial string and the deactivation string are determined to be the same, the RFID tag deactivates itself or configures itself to permit deactivation.

Another aspect of the invention includes an RFID tag having a transceiver for communicating with an RFID tag reader; memory for storing a deactivation string, for storing an encrypted deactivation string created externally to the RFID tag by encrypting the deactivation string, and for storing a trial string created externally to the RFID tag by reading the encrypted deactivation string from the memory using the transceiver and decrypting the encrypted deactivation string to provide the trial string. The RFID tag also includes logic for comparing the deactivation string and the trial string to determine whether the deactivation string and the trial string are the same, and, if the deactivation string and the trial string are the same, deactivating the RFID tag or configuring the RFID tag to permit deactivation.

### BRIEF DESCRIPTION OF THE SEVERAL VIEWS OF THE DRAWINGS

These and other aspects of the invention may be understood more fully by reading the following detailed description together with the drawings, wherein:

FIG. 1 shows an exemplary block diagram of an ordinary RFID tag;

FIG. 2 shows an exemplary block diagram of an RFID tag according to aspects of the invention; and

FIG. 3 shows aspects of a method for controlling the RFID tag of FIG. 2, according to the invention.

### DETAILED DESCRIPTION

The present invention will now be described more fully hereinafter, with reference to the accompanying drawings, in which illustrative embodiments of the invention are shown. Throughout the drawings, like numbers refer to like elements.

The invention may, however, be embodied in many different forms, and should not be construed as limited to the embodiments set forth herein; rather, these embodiments are provided so that the disclosure will be thorough and complete, and will fully convey the scope of the invention to those skilled in the art.

As will be appreciated by one of skill in the art, the present invention may be embodied as a method, system, or tangibly embodied computer program code. Accordingly, the present invention may take the form of an embodiment entirely in hardware, entirely in software, or in a combination of aspects in hardware and software referred to as circuits and modules.

Furthermore, the present invention may take the form of a computer program product on a computer-usable storage medium having computer-usable program code embodied in the medium. Any suitable computer-readable medium may be utilized, including hard disks, CD-ROMs, optical storage devices, magnetic storage devices, and transmission media such as those supporting the Internet or an intranet.

Computer program code for carrying out operations of the present invention may be written in an object oriented programming language such as Java, Smalltalk, or C++. However, the computer program code for carrying out operations of the present invention may also be written in conventional procedural programming languages, such as the C programming language.

The present invention is described below with reference to flowchart illustrations and/or block diagrams of methods, apparatus (systems), and computer program products according to embodiments of the invention. It will be understood that each block of the flowchart illustrations and/or block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions and/or acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the functions or acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions and/or acts specified in the flowchart and/or block diagram block or blocks.

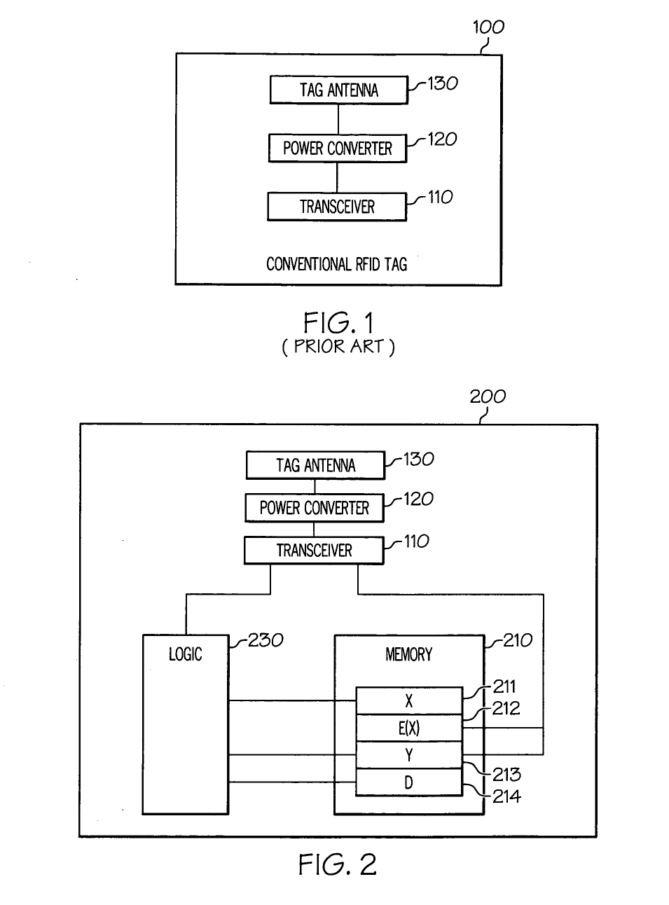

FIG. 1 shows a block diagram of a conventional RFID tag. This diagram is introduced mainly as a descriptive convenience to be used in clearly differentiating the inventive RFID tag 200 described below with reference to FIG. 2 from the conventional RFID tag of FIG. 1.

As shown in FIG. 1, a conventional RFID tag 100 comprises a transceiver 110, a power converter 120, and a tag antenna 130. As is well known to those skilled in the art, a conventional passive RFID tag receives electromagnetic energy through the tag antenna 130 when queried by a tag reader. The power converter 120, which may be, for example, a rectifier and a simple filter such as a capacitor, transforms the received energy into a form suitable to power the transceiver 110, in order that the transceiver 110 may respond to the tag reader. In contrast to passive RFID tags, active RFID tags may include an internal power source such as a small battery, thereby eliminating the need to power the transceiver 110 from energy received by the tag antenna 130. Since conventional RFID tags both passive and active are well known to those skilled in the art, no further elaboration will be given here.

FIG. 2 shows an exemplary block diagram of a controlled deactivation RFID tag 200. The controlled deactivation RFID tag 200 of FIG. 2 includes a transceiver 110 for communicating with an RFID tag reader (not shown), a power converter 120, and a tag antenna 130. These components work substantially as described above with reference to FIG. 1, although with an important exception. The exception is that the RFID tag 200 may self-configure to deactivate or to permit deactivation of one or more of the components 110, 120, and 130, under conditions described below, to deactivate the tag or configure the tag to permit deactivation. In a preferred embodiment of the invention, deactivation may be permanent, which means that the RFID tag 200 cannot be reactivated, once deactivated, to operate again.

The RFID tag 200 may be deactivated by, for example, disconnecting or discontinuing the supply of power from the power converter 120 to the transceiver 110; by opening the path between the transceiver 110 and the tag antenna 130, or by diverting the tag antenna 130 or the output of the transceiver 110 to ground directly or through a dummy load; by opening or closing a link or switch internal to the transceiver 110; by erasing or altering contents of a memory read by the transceiver 110; and so forth. The RFID tag 200 may configure to permit deactivation by, for example, altering contents of a memory read by the transceiver 110, so that the transceiver 110 may be deactivated at a later time as described above. In other embodiments, the RFID tag 200 may configure to permit deactivation by closing or opening a link or switch in the transceiver 110 to permit deactivation at a later time, for example the next time an attempt is made to read the RFID tag 200, or to permit deactivation upon exciting the RFID tag 200 with apparatus that has the purpose of deactivating the RFID tag 200 but that remains thwarted in attempts to deactivate the tag until the aforementioned link or switch is opened or closed, and so forth. Hereinafter, deactivating and configuring to permit deactivation are collectively referred to as configuring to permit deactivation, in the interest of brevity.

The RFID tag 200 may include memory 210. The memory 210 may be a single semiconductor unit, for example, or may include various memories of various kinds disbursed throughout the RFID transceiver 200. In any case, memory 210 may be conveniently thought of as having address space or registers for a deactivation string memory 211, an encrypted deactivation string memory 212, a trial string memory 213, and a deactivation flag memory 214. The deactivation string memory 211 and encrypted deactivation string memory 212 may be written once when the RFID tag 200 is initially configured. From the point of view of an RFID tag reader, the deactivation string memory 211 may not be written, loaded, or read through the transceiver 110; the encrypted deactivation string memory 212 may be read by an RFID tag reader but neither written nor loaded; the trial string memory 213 may be loaded but not read, and the deactivation flag memory 214 may not be written, loaded, or read through the transceiver 110.

The RFID tag 200 may further include logic 230, which may be a simple digital comparator, or a processor, or special-purpose circuitry, and so forth. One purpose of the logic 230 is to compare the contents of the deactivation string memory 211 and the trial string memory 213, to determine whether the deactivation string and the trial string are the same, and, if they are the same, to configure the RFID tag 200 to permit deactivation as described above. The deactivation flag memory 214, whose contents are referred to here as D, may be used to indicate that the RFID tag 200 is configured to permit deactivation.

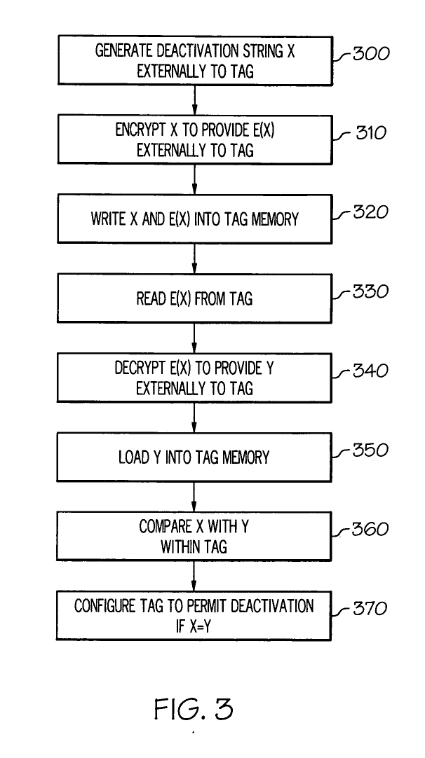

FIG. 3 shows aspects of a method for controlling the RFID tag 200 exemplified in FIG. 2. As shown in FIG. 3, a deactivation string is generated (block 300). The deactivation string may be, for example, a 128-bit binary sequence, and is called here X. In a preferred embodiment of the invention, each individual RFID tag has a unique or locally unique deactivation string. Uniqueness is not, however, a condition of the invention, as the same deactivation string may be used for more than one RFID tag. The deactivation string may be generated externally to the RFID tag 200, meaning that the RFID tag 200 does not need to have internal apparatus capable of generating the deactivation string.

The deactivation string X is encrypted (block 310), to provide an encrypted deactivation string, which is called here E(X). Encryption may be done externally to the RFID tag 200. In a preferred embodiment of the invention, the deactivation string is encrypted using a public key of a public encryption algorithm. The public key encryption algorithm may be an asymmetrical public key encryption algorithm, although this is not a necessary condition of the invention. For example, if the RFID tag 200 is used to track an item that is destined to a particular retail merchant, the encryption key may be a public key of that merchant. In other embodiments of the invention, the key used to encrypt the deactivation string may be a private encryption key selected by, for example, the aforementioned merchant. Any reasonably robust encryption algorithm may be employed; absolute security is not an essential condition.

The deactivation string X and the encrypted deactivation string E(X) are written into the memory 210 of the RFID tag 200 in the address spaces called 211 and 212 above, respectively (Block 320). Here, the term “written” is used rather than “loaded” to suggest, but not require, long-term persistence or permanence.

The deactivation string and the encrypted deactivation string may be created or written into the memory 210 at various stages of the life of an item that is to be tracked using the RFID tag 200. For example, writing an RFID tag may be part of the process of manufacturing the item, or part of the process of distributing the item. Also, the RFID tag may be written apart from the manufacturing of the item. Such situations are called here pre-sale, meaning that the deactivation string and the encrypted deactivation string are created and written before the item enters its sales channel.

When the question of deactivating the RFID tag 200 becomes topical, for example when an item tracked by the RFID tag 200 is sold in a retail outlet, the encrypted deactivation string E(X) is read from the RFID tag 200, using, for example, an RFID tag reader (Block 330). The encrypted deactivation string is then decrypted (Block 340) externally to the RFID tag 200, to provide a trial string called here Y. If the encryption was done according to a public key algorithm, the encrypted deactivation string may be decrypted using a private key that pairs with the public key used to encrypt. In other embodiments of the invention, a private key may be used to both encrypt and decrypt.

The trial string Y is then loaded into the memory 200 (Block 350), in the address space called 213 earlier, using, for example, an RFID tag reader which may have the capability to write as well as to read RFID tags.

Reading the encrypted deactivation tag E(X), decrypting E(X) to provide Y, and loading Y into the memory 210 may be accomplished when, for example, an item tracked by the RFID tag 200 is sold by a retail merchant. For this reason, these operations are referred to here as being part of the sales process for the tracked item. The retail merchant may provide the RFID tag reader, which may be connected to a point-of-sale terminal.

The logic 230 within the RFID tag 200 then compares X, which is the deactivation string, with Y, which is the decrypted version of E(x), to determine whether X and Y are the same (Block 360). If the determination is that X and Y are the same, the RFID tag 200 configures to permit deactivation (block 370), as described earlier with reference to FIG. 2. Thus, the RFID tag 200 may be deactivated by, for example, a retail merchant at the time of sale, or later on by, for example, a consumer who takes delivery of an item tracked by the RFID tag 200.

Although the foregoing has described methods and apparatus for controlling deactivation of RFID tags, the description of the invention is illustrative rather than limiting; the invention is limited only by the claims that follow.

We claim:

1. A method executed by an RFID tag, comprising: comparing a trial string with a deactivation string, to determine whether the deactivation string and the trial string are the same, and if it is determined that the trial string and the deactivation string are the same, configuring the RFID tag to permit deactivation; wherein an encrypted deactivation string is created externally to the RFID tag by encrypting the deactivation string, using a first key, and the trial string is created externally to the RFID tag by decrypting the encrypted deactivation string, using a second key.

2. The method of claim 1, wherein the first key is a public key and the second key is a private key, said keys being suitable for use in public-key encryption.

3. The method of claim 1, wherein the first key and the second key are suitable for use in private-key encryption.

4. The method of claim 1, wherein the trial string is created as part of a sales process for an item tracked by the RFID tag, and the encrypted deactivation string is created as part of a pre-sales process.

5. The method of claim 4, wherein the pre-sales process is a manufacturing process for the item tracked by the RFID tag.

6. The method of claim 4, wherein the pre-sales process is a distribution process for the item tracked by the RFID tag.

7. The method of claim 4, wherein the pre-sales process is a manufacturing process for the RFID tag.

8. A method for controlling an RFID tag, comprising:
encrypting a deactivation string using a first key, to provide an encrypted deactivation string;
writing the deactivation string and the encrypted deactivation string into memory of an RFID tag;
reading the encrypted deactivation string from the RFID tag;
decrypting the encrypted deactivation string using a second key, to provide a trial string;
loading the trial string into memory of the RFID tag; and
by the RFID tag, comparing the trial string loaded into the RFID tag with the deactivation string written into the RFID tag to determine whether the trial string and the deactivation string are the same, and configuring the RFID tag to permit deactivation if the trial string and the deactivation string are determined to be the same.

9. The method of claim 8, wherein the first key is a public key and the second key is a private key, said keys being suitable for use in public-key encryption.

10. The method of claim 8, wherein the first key and the second key are suitable for use in private-key encryption.

11. The method of claim 8, wherein reading the encrypted deactivation string from the RFID tag, decrypting the encrypted deactivation string to provide a trial string, and loading the trial string into memory of the RFID tag are part of a sales process for an item tracked by the RFID tag; and encrypting the deactivation string and writing the deactivation string and the encrypted deactivation string into memory of the RFID tag are part of a pre-sales process.

12. The method of claim 11, wherein the pre-sales process is a manufacturing process for the item tracked by the RFID tag.

13. The method of claim 11, wherein the pre-sales process is a distribution process for the item tracked by the RFID tag.

14. The method of claim 11, wherein the pre-sales process is a manufacturing process of the RFID tag.

15. An RFID tag, comprising:
a transceiver for communicating with an RFID tag reader;
memory for storing a deactivation string, for storing an encrypted deactivation string created externally to the RFID tag by encrypting the deactivation string, and for storing a trial string created externally to the RFID tag by reading the encrypted deactivation string from the memory, and decrypting the encrypted deactivation string to provide the trial string; and
logic for comparing the deactivation string and the trial string to determine whether the deactivation string and the trial string are the same, and, if the deactivation string and the trial string are determined to be the same, configuring the RFID tag to permit deactivation.
